(19) United States
(12) Patent Application Publication
(10) Pub. No.: US 2004/0211289 A1
(43) Pub. Date: Oct. 28, 2004

(54) Crank structure of bicycle

(76) Inventors: Cheng-Hsun Chiang, Taichung (TW); David Michael Anthony, Taichung (TW)

Correspondence Address: Cheng-Hsun Chiang, 58 MA YUAN WEST ST., TAICHUNG, TW

(21) Appl. No.: 10/423,611

(22) Filed: Apr. 25, 2003

(51) Int. Cl. G05G 1/14

(52) U.S. Cl. 74/594.1

(57) ABSTRACT

A crank structure includes a first combination block, a second combination block, a core layer, a resin layer, and an outer layer. Thus, the crank structure is formed by and entirely coated with the carbon fiber material without providing any metallic material, so that the crank structure has a light weight, thereby decreasing the whole weight. In addition, the crank structure is entirely coated with the carbon fiber material without forming any connection points, thereby enhancing strength and stiffness of the crank structure.

### BACKGROUND OF THE INVENTION

1. Field of the Invention

The present invention relates to a crank structure, and more particularly to a crank structure of a bicycle.

2. Description of the Related Art

A conventional crank of a bicycle in accordance with the prior art has a front end provided with a primary aluminum member which has an end provided with a wing plate, and has a rear end provided with a secondary aluminum member which has an end provided with a wing plate. The crank also comprises a carbon fiber coated on the primary aluminum member and the secondary aluminum member, thereby forming the crank.

However, the conventional crank mainly consists of two different materials, including the metallic material and the carbon fiber material, thereby decreasing the structural strength of the crank. In addition, the conventional crank is provided with the primary aluminum member and the secondary aluminum member, thereby increasing the whole weight of the crank. Further, it is necessary to form the primary aluminum member and the wing plate, the secondary aluminum member and the wing plate, and to coat the carbon fiber on the primary aluminum member and the secondary aluminum member, thereby complicating the procedures of fabrication.

### SUMMARY OF THE INVENTION

The primary objective of the present invention is to provide a crank structure that is formed by and entirely coated with the carbon fiber material without providing any metallic material, so that the crank structure has a light weight, thereby decreasing the whole weight.

Another objective of the present invention is to provide a crank structure that is integrally formed with the claw portion which is entirely coated with the carbon fiber material, thereby simplifying the fabrication, and thereby decreasing the whole weight.

A further objective of the present invention is to provide a crank structure that is entirely coated with the carbon fiber material without forming any connection points, thereby enhancing strength and stiffness of the crank structure.

A further objective of the present invention is to provide a crank structure that is entirely coated with the carbon fiber material which can be made to form any configuration and pattern freely and easily, thereby greatly enhancing the aesthetic quality of the crank structure.

In accordance with the present invention, there is provided a crank structure, comprising:

a first combination block;

a second combination block; and

a core layer mounted between the first combination block and the second combination block and having two ends respectively coated on the first combination block and the second combination block.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a crank structure in accordance with the preferred embodiment of the present invention;

FIG. 2 is a partially perspective cross-sectional view of the crank structure in accordance with the preferred embodiment of the present invention;

FIG. 3 is a side plan cross-sectional view of the crank structure as shown in FIG. 1;

FIG. 4 is a partially perspective view of the crank structure in accordance with the preferred embodiment of the present invention;

FIG. 5 is a side plan cross-sectional view of the crank structure as shown in FIG. 4;

FIG. 6 is a perspective view of a crank structure in accordance with another embodiment of the present invention;

FIG. 7 is a partially perspective cross-sectional view of the crank structure in accordance with another embodiment of the present invention;

FIG. 8 is a side plan cross-sectional view of the crank structure as shown in FIG. 6;

FIG. 9 is a partially perspective view of the crank structure in accordance with another embodiment of the present invention; and

FIG. 10 is a side plan cross-sectional view of the crank structure as shown in FIG. 9.

### DETAILED DESCRIPTION OF THE INVENTION

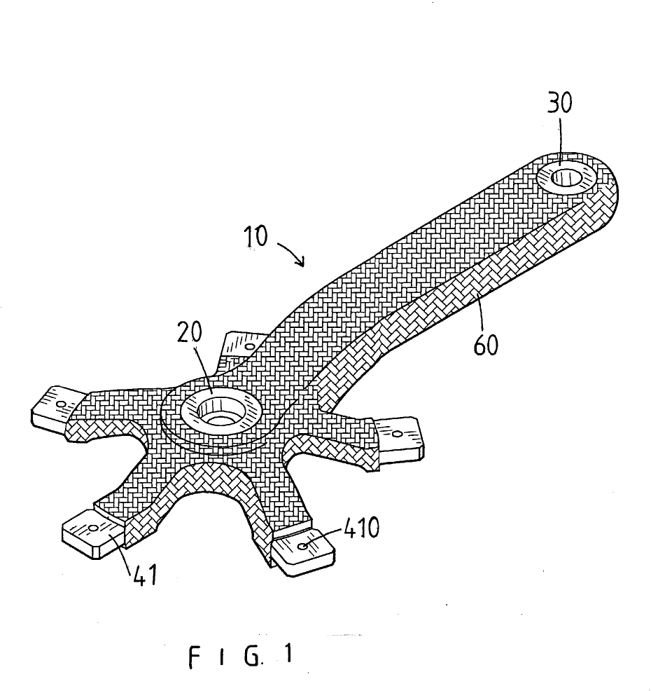

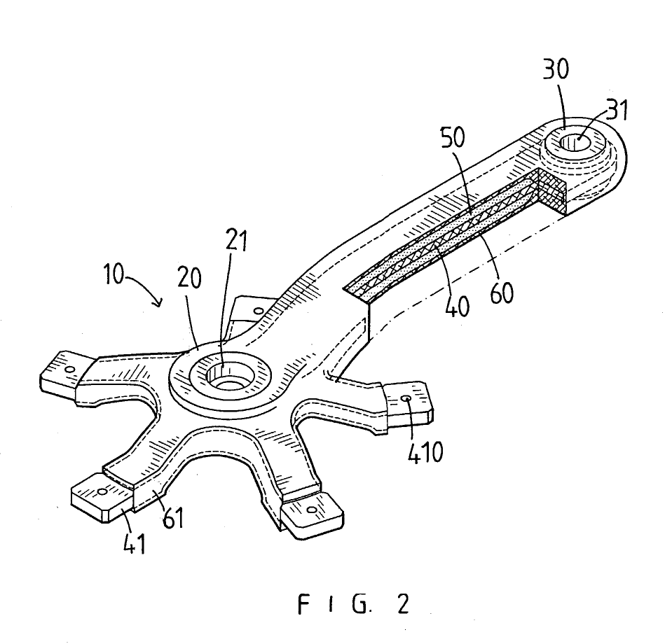

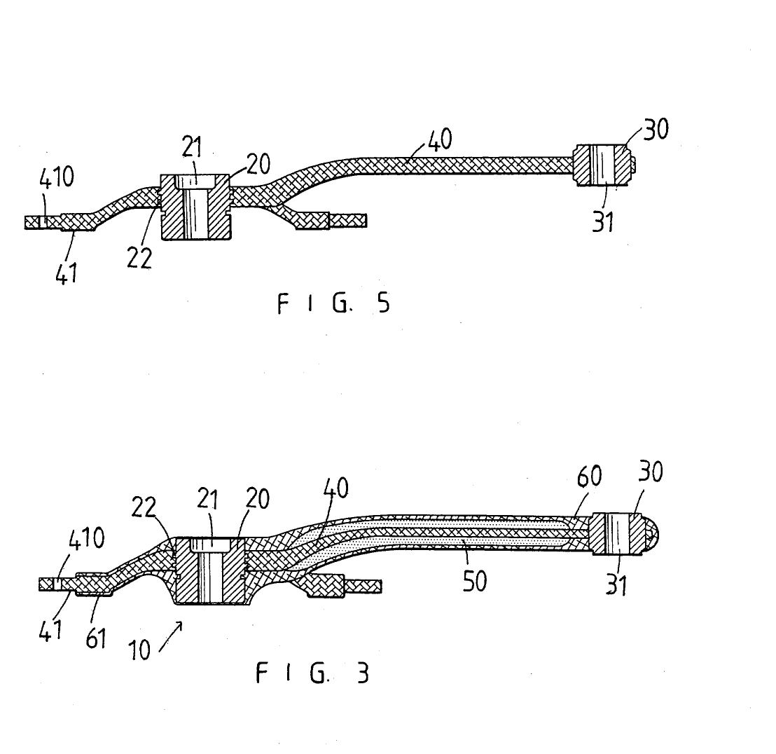

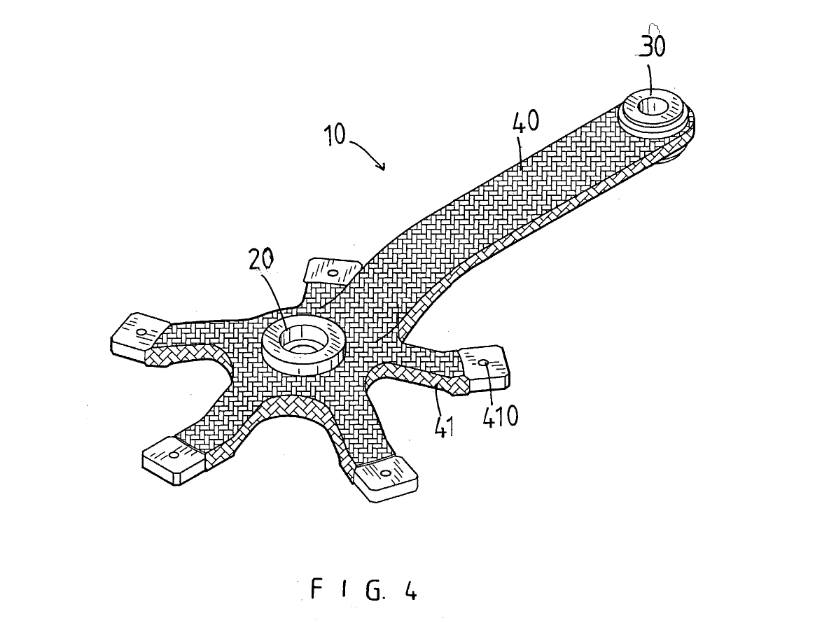

Referring to the drawings and initially to FIGS. 1-5, a crank structure 10 of a bicycle in accordance with the preferred embodiment of the present invention comprises a first combination block 20, a second combination block 30, a core layer 40, a resin layer 50, and an outer layer 60.

The first combination block 20 is coated with a carbon fiber. The first combination block 20 has an inner wall formed with a through hole 21 and an outer wall formed with at least one annular protruding ring 22. In such a manner, the protruding ring 22 of the first combination block 20 can increase the connection area between the first combination block 20 and the carbon fiber.

The second combination block 30 is coated with a carbon fiber. The second combination block 30 has an inner wall formed with a through hole 31.

The core layer 40 is made of a carbon fiber, and is mounted between the first combination block 20 and the second combination block 30. The core layer 40 has a distal end formed with a claw portion 41 surrounding the first combination block 20. The claw portion 41 of the core layer 40 is formed with a plurality of through holes 410.

The protruding ring 22 of the first combination block 20 is combined with the core layer 40 to increase the connection area between the first combination block 20 and the core layer 40, so that the first combination block 20 is combined with the core layer 40 rigidly and stably.

The resin layer 50 is coated on a periphery of the core layer 40.

The outer layer 60 is made of a carbon fiber, and is coated on the first combination block 20, the second combination block 30 and the resin layer 50. The outer layer 60 has a distal end formed with a claw portion 61 coated on the claw portion 41 of the core layer 40.

Accordingly, the crank structure 10 in accordance with the present invention has the following advantages.

1. The crank structure 10 is formed by and entirely coated with the carbon fiber material without providing any metallic material, so that the crank structure 10 has a light weight, thereby decreasing the whole weight.

2. The crank structure 10 is integrally formed with the claw portion which is entirely coated with the carbon fiber material, thereby simplifying the fabrication, and thereby decreasing the whole weight.

3. The crank structure 10 is entirely coated with the carbon fiber material without forming any connection points, thereby enhancing strength and stiffness of the crank structure 10.

4. The crank structure 10 is entirely coated with the carbon fiber material which can be made to form any configuration and pattern freely and easily, thereby greatly enhancing the aesthetic quality of the crank structure 10.

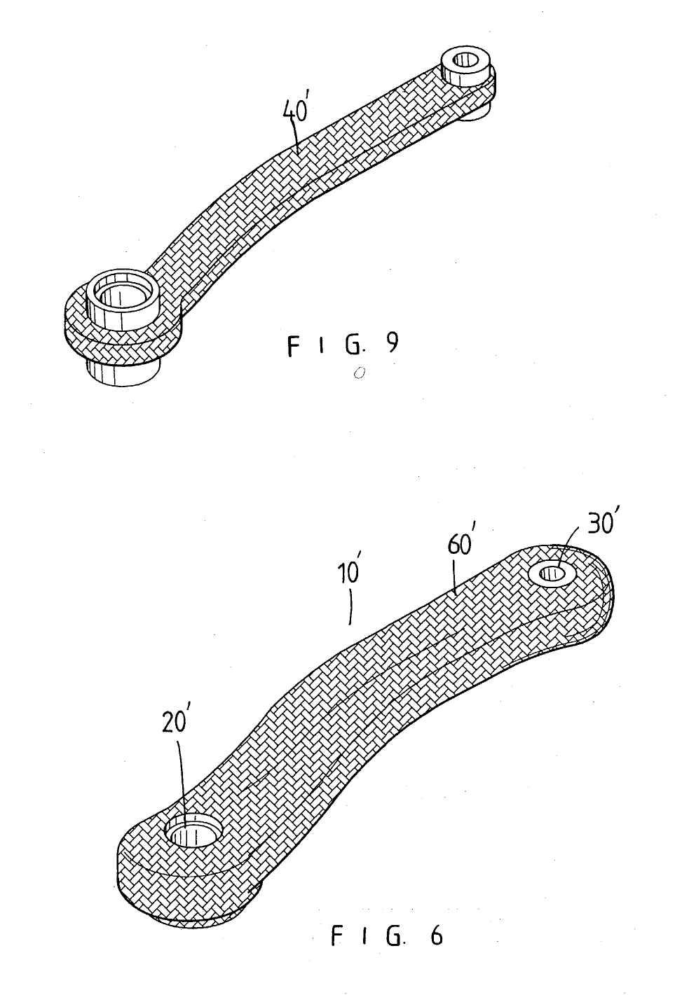

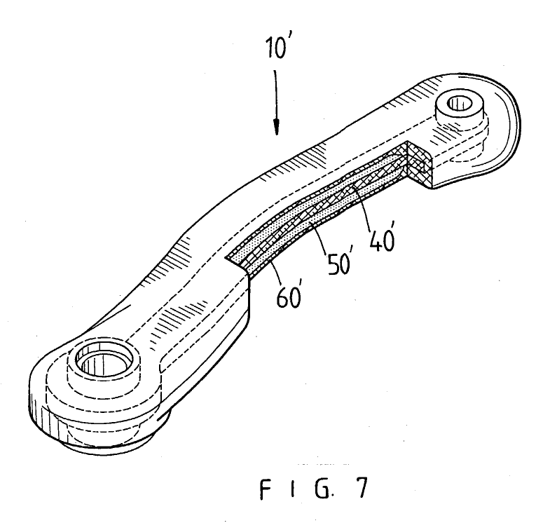

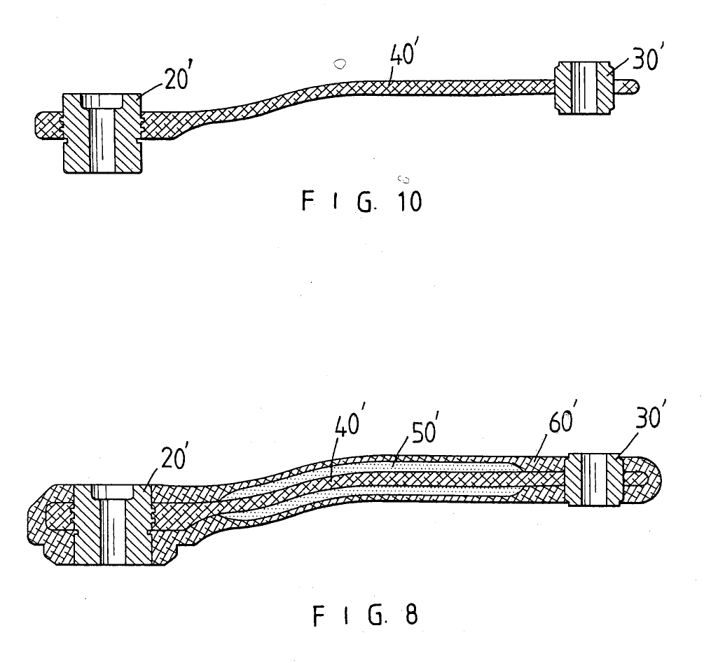

Referring to FIGS. 6-10, the crank structure 10′ of a bicycle in accordance with another embodiment of the present invention comprises a first combination block 20′, a second combination block 30′, a core layer 40′, a resin layer 50′, and an outer layer 60′. The construction and feature of the crank structure 10′ is similar to that of the crank structure 10 and will not be further described in detail.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A crank structure, comprising:
a first combination block;
a second combination block; and
a core layer mounted between the first combination block and the second combination block and having two ends respectively coated on the first combination block and the second combination block.

2. The crank structure in accordance with claim 1, wherein the core layer is made of a carbon fiber.

3. The crank structure in accordance with claim 1, further comprising an outer layer coated on a periphery of the core layer.

4. The crank structure in accordance with claim 3, wherein the outer layer is made of a carbon fiber.

5. The crank structure in accordance with claim 3, wherein the outer layer is coated on the first combination block, the second combination block and the core layer.

6. The crank structure in accordance with claim 3, wherein the core layer has a distal end formed with a claw portion surrounding the first combination block, and the outer layer has a distal end formed with a claw portion coated on the claw portion of the core layer.

7. The crank structure in accordance with claim 6, wherein the claw portion of the core layer is formed with a plurality of through holes.

8. The crank structure in accordance with claim 3, further comprising a resin layer mounted between the core layer and the outer layer.

9. The crank structure in accordance with claim 1, wherein the first combination block has an inner wall formed with a through hole.

10. The crank structure in accordance with claim 1, wherein the first combination block has an outer wall formed with at least one annular protruding ring combined with the core layer.

11. The crank structure in accordance with claim 1, wherein the second combination block has an inner wall formed with a through hole.
